(19) United States
(12) Patent Application Publication
(10) Pub. No.: US 2012/0235489 A1
(43) Pub. Date: Sep. 20, 2012

(54) ELECTRONIC APPARATUS AND POWER SUPPLY CONTROL METHOD

(75) Inventors: Kimiyasu NAMEKAWA, Tokyo (JP); Guanying Fan, Kanagawa (JP)

(73) Assignee: SONY CORPORATION, Tokyo (JP)

(21) Appl. No.: 13/363,855

(22) Filed: Feb. 1, 2012

(30) Foreign Application Priority Data
Mar. 18, 2011 (JP) 2011-060895

(51) Int. Cl. H02J 9/00

(52) U.S. Cl. 307/66

(57) ABSTRACT

There is provided an electronic apparatus including a first battery and a second battery, a control unit configured to control an operation of the electronic apparatus, a first switch configured to switch whether or not to supply power from the first battery to the control unit, and a second switch configured to switch whether or not to supply a potential from the second battery to the first switch. When power from the first battery is supplied to the control unit, the control unit applies to the first switch a potential for supplying power from the first battery to the control unit.

### BACKGROUND

The present disclosure relates to an electronic apparatus and a power supply control method.

Functions of mobile electronic apparatuses such as digital still cameras, digital video cameras, portable phones, or portable audio players have been dramatically improved in response to an increasing demand in recent years. Meanwhile, power consumption of such mobile electronic apparatuses has also increased in accordance with the improved functions. Thus, a reduction in power consumption is a big object to be achieved in the field of such mobile electronic apparatuses.

Among the types of power consumed by a mobile electronic apparatus are power that is consumed while the mobile electronic apparatus is used and standby power that is consumed while the mobile electronic apparatus is not used. The standby power is generated as some of the internal devices are supplied with power to shorten the starting time of the apparatus. The power consumed while the mobile electronic apparatus is used has influence on the operating time of the mobile electronic apparatus. Meanwhile, the standby power consumed while the mobile electronic apparatus is not used has influence on the operable time of the mobile electronic apparatus after it has not been used for a long period of time.

In recent years, greater importance has been placed not only on, of course, prolonging the operating time of mobile electronic apparatuses by reducing the power consumed while the mobile electronic apparatuses are used, but also on prolonging the operable time of mobile electronic apparatuses after the mobile electronic apparatuses have not been used for a long period of time by reducing the standby power consumed while the mobile electronic apparatuses are not used.

For example, many of users of digital cameras use their cameras only once a week or once a month. When the standby power is high, the users will not be able to use their digital cameras soon, and should start charging batteries before using the digital cameras. This will cause inconvenience to the users of the digital cameras as the digital cameras cannot be used soon even when they want to.

As a method for reducing the standby power consumed by a mobile electronic apparatus while it is not used, there is known an invention for reducing the operating clocks of a control circuit or operating a CPU (Central Processing Unit) in a sleep mode (see JP H9-191569A, for example).

### SUMMARY

However, although the aforementioned invention for reducing the standby power consumed by a mobile electronic apparatus while it is not used can reduce the power consumption, the minimum operating power for operating an IC (Integrated Circuit) is still needed. Thus, there has been a problem that such an invention is insufficient as a measure to prolong the operable time of the mobile electronic apparatus after it has not been used.

Thus, as a measure to prolong the operable time of a mobile electronic apparatus, ingenuity is needed for reducing the standby power of the mobile electronic apparatus close to zero. For example, by providing a switch between a battery and an internal base and turning the switch off when the mobile electronic apparatus is not used, it becomes possible to suppress the power consumed by the battery due to factors other than self-discharge.

However, mobile electronic apparatuses typically have ICs mounted thereon. Thus, if the switch is just turned off when the mobile electronic apparatus is not used, there is a possibility that power supply to the IC may be shut off while the IC is driven, which could disturb the function of the IC, and could, in the worst case, destroy the IC or peripheral circuits thereof. Such disturbance of the function of the IC may occur when, for example, power supply to the IC is shut off while a process of saving a captured image is executed, so the captured image would be discarded without being saved.

In light of the foregoing, it is desirable to provide an electronic apparatus and a power supply control method that are novel and improved and that can prolong the operable time of the electronic apparatus after the electronic apparatus has not been used.

According to an embodiment of the present disclosure, there is provided an electronic apparatus including a first battery and a second battery, a control unit configured to control an operation of the electronic apparatus, a first switch configured to switch whether or not to supply power from the first battery to the control unit, and a second switch configured to switch whether or not to supply a potential from the second battery to the first switch. When power from the first battery is supplied to the control unit, the control unit applies to the first switch a potential for supplying power from the first battery to the control unit.

The control unit may, upon detecting that the second switch has set a stop of power supply from the first battery and a stop of an operation of the control unit, stop supplying a potential to the first switch and turn the first switch off after completing a process being executed.

The control unit may have a terminal that detects a start and a stop of the power supply from the first battery by the second switch.

When the control unit outputs a potential for maintaining an on-state of the first switch, the second battery may stop supplying a potential to the first switch.

The potential output from the control unit to the first switch may be higher than the potential output from the second battery to the first switch.

The second battery may have lower capacity than the first battery.

The first switch may include a first FET and a second FET, the first FET being configured to be turned on upon being supplied with a potential from the second battery by the second switch, and the second FET being configured to be turned on when the first FET is turned on and supply power from the first battery to the control unit.

According to another embodiment of the present disclosure, there is provided a power supply control method for an electronic apparatus, the electronic apparatus including a first battery and a second battery, a control unit configured to control an operation of the electronic apparatus, a first switch configured to switch whether or not to supply power from the first battery to the control unit, and a second switch configured to switch whether or not to supply a potential from the second battery to the first switch, the method including applying a potential from the second battery to the first switch by the second switch, and applying to the first switch, when the first switch is turned on and power from the first battery is supplied to the control unit, a potential for supplying power from the first battery to the control unit.

According to the embodiments of the present disclosure described above, it is possible to provide an electronic apparatus and a power supply control method that are novel and improved and that can prolong the operable time of the mobile electronic apparatus after the electronic apparatus has not been used.

### BRIEF DESCRIPTION OF THE DRAWINGS

FIG. 1 is an explanatory diagram showing an example of the appearance of an electronic apparatus 100 in accordance with an embodiment of the present disclosure;

FIG. 2 is an explanatory diagram showing the functional configuration of the electronic apparatus 100 in accordance with an embodiment of the present disclosure;

FIG. 3 is an explanatory diagram showing a circuit configuration example of the electronic apparatus 100 in accordance with an embodiment of the present disclosure;

FIG. 4 is an explanatory diagram showing a configuration example of a control IC 150;

FIG. 5 is an explanatory table showing the relationship between the states of input ports A and B of the control IC 150 and the operation mode of the electronic apparatus 100; and

FIG. 6 is a flowchart showing the operation of the electronic apparatus 100 in accordance with an embodiment of the present disclosure.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted by the same reference numerals, and repeated explanation of these structural elements is omitted.

Note that the description will be given in the following order.

### <1. Embodiment of the Present Disclosure>

### [1-1. Example of Appearance of Electronic Apparatus]

### [1-2. Functional Configuration of Electronic Apparatus]

### [1-3. Circuit Configuration Example of Electronic Apparatus]

### [1-4. Operation of Electronic Apparatus]

### <2. Conclusion>

### 1. Embodiment of the Present Disclosure

### [1-1. Example of Appearance of Electronic Apparatus]

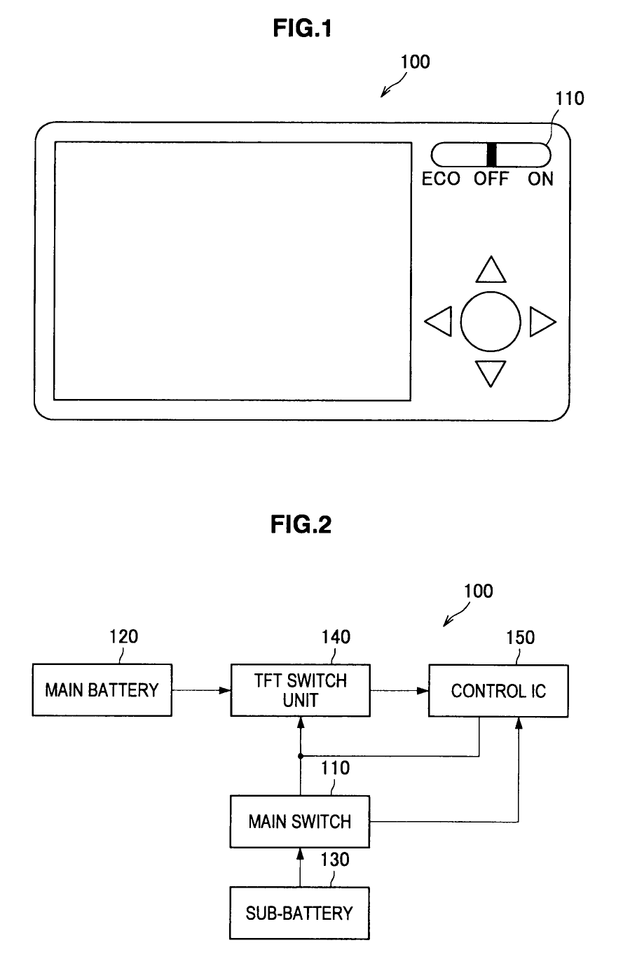

First, an example of the appearance of an electronic apparatus in accordance with an embodiment of the present disclosure will be described. FIG. 1 is an explanatory diagram showing an example of the appearance of an electronic apparatus 100 in accordance with an embodiment of the present disclosure. Hereinafter, an example of the appearance of the electronic apparatus 100 in accordance with an embodiment of the present disclosure will be described.

The electronic apparatus 100 in accordance with an embodiment of the present disclosure is a digital camera shown in FIG. 1, for example. FIG. 1 is an explanatory diagram showing the state of the electronic apparatus 100 seen from the rear side. The electronic apparatus 100 shown in FIG. 1 has functions capable of capturing a still image or a moving image in response to a user operation, and storing data of the captured image into a recording medium in the apparatus.

The electronic apparatus 100 in accordance with an embodiment of the present disclosure has a main switch 110 as shown in FIG. 1. The main switch 110 is a switch for turning the power of the electronic apparatus 100 on/off. A user of the electronic apparatus 100 can turn the power of the electronic apparatus 100 on/off by operating the main switch 110. In the following description, a state in which the power of the electronic apparatus 100 is turned on by the main switch 110 will be rephrased as: the operation mode of the electronic apparatus 100 is a power-on mode. Meanwhile, a state in which the power of the electronic apparatus 100 is turned off will be rephrased as: the operation mode of the electronic apparatus 100 is a power-off mode. FIG. 1 shows a state in which the operation mode of the electronic apparatus 100 is set to the power-off mode by the main switch 110.

Note that even when the electronic apparatus 100 is in the power-off mode, not all the circuits in the electronic apparatus 100 stop operation, but the minimum circuits (e.g., a control IC described below) are supplied with power. Accordingly, the starting time when the user operates the main switch 110 to turn the power of the electronic apparatus 100 on can be shortened.

The main switch 110 provided on the electronic apparatus 100 in accordance with an embodiment of the present disclosure has, in addition to the power-on mode and the power-off mode of the electronic apparatus 100, a mode for prolonging the operable time of the electronic apparatus after the electronic apparatus has not been used, by stopping power supply to the circuits that operate even in the power-off mode. In the following description, the operation mode for prolonging the operable time of the electronic apparatus after the electronic apparatus has not been used will be referred to as an “eco-mode.”

Note that when the user of the electronic apparatus 100 operates the main switch 110 to suddenly change the operation mode of the electronic apparatus 100 from the power-on mode to the eco-mode, there is a possibility that power supply to the IC may be shut off while the IC is driven, which could disturb the function of the IC, and could, in the worst case, destroy the IC or peripheral circuits thereof, as described above. For the electronic apparatus 100 in accordance with an embodiment of the present disclosure shown in FIG. 1, a case is considered in which if power supply to the IC is shut off while a process of saving a captured image is executed, the captured image may be discarded without being saved.

Hereinafter, a configuration and an operation for, even when the user of the electronic apparatus 100 in accordance with an embodiment of the present disclosure operates the main switch 110 to suddenly change the operation mode of the electronic apparatus 100 to the eco-mode, avoiding the aforementioned problem will be described in detail.

An example of the appearance of the electronic apparatus 100 in accordance with an embodiment of the present disclosure has been described with reference to FIG. 1. Needless to say, an example of the electronic apparatus is not limited to the digital camera shown in FIG. 1, and an embodiment of the present disclosure described below can be applied to all electronic apparatuses that consume a given amount of power even when the power is turned off. Next, a function and an operation of the electronic apparatus 100 in accordance with an embodiment of the present disclosure will be described.

### [1-2. Functional Configuration of Electronic Apparatus]

FIG. 2 is an explanatory diagram showing the functional configuration of the electronic apparatus 100 in accordance with an embodiment of the present disclosure. Hereinafter, a functional configuration of the electronic apparatus 100 in accordance with an embodiment of the present disclosure will be described with reference to FIG. 2.

As shown in FIG. 2, the electronic apparatus 100 in accordance with an embodiment of the present disclosure includes the main switch 110, a main battery 120, a sub-battery 130, a FET switch unit 140, and a control IC 150.

The main switch 110 is a switch for turning the power of the electronic apparatus 100 on and off, and is also a switch for controlling on/off the FET switch unit 140. The main switch 110 includes at least a terminal (on-terminal) for turning the power of the electronic apparatus 100 on and a terminal (an eco-mode terminal) for turning the power of the electronic apparatus 100 off and completely stopping the operation of the control IC 150. When the user of the electronic apparatus 100 operates the main switch 110, the electronic apparatus 100 changes operation mode among the power-on mode, the power-off mode, and the eco-mode.

In a state in which the main switch 110 is connected to the on-terminal, a potential from the sub-battery 130 is output to the FET switch unit 140. The potential output from the sub-battery 130 to the FET switch unit 140 is a potential that is high enough to turn the FET switch unit 140 on.

The main battery 120 holds power for driving various devices and circuits mounted in the electronic apparatus 100. In FIG. 2, the control IC 150 is shown as an example of the various devices and circuits mounted in the electronic apparatus 100. Needless to say, the various devices and circuits mounted in the electronic apparatus 100 are not limited to the control IC 150, and can include, for example, a display for displaying a screen, a lens for capturing an image of a subject, and a circuit for driving a focus.

The sub-battery 130 is a battery provided separately from the main battery 120. The capacity of the sub-battery 130 can be lower than that of the main battery 120. For example, the sub-battery 130 is a battery for operating an RTC (Real Time Clock, not shown), which operates in the electronic apparatus 100, by supplying power to the RTC even when the operation of the electronic apparatus 100 completely stops. In the electronic apparatus 100 in accordance with this embodiment, the FET switch unit 140 can be turned on by a potential output from the sub-battery 130.

The FET switch unit 140 controls power supply to the various devices and circuits mounted in the electronic apparatus 100 from the main battery 120. When the FET switch unit 140 is turned on, power is supplied from the main battery 120 to the various devices and circuits mounted in the electronic apparatus 100. When the FET switch unit 140 is turned off, power supply from the main battery 120 to the various devices and circuits mounted in the electronic apparatus 100 stops.

The control IC 150 is an IC that controls the operation of the electronic apparatus 100. The control IC 150 operates upon being supplied with power from the main battery 120, and controls the various devices mounted in the electronic apparatus 100, for example, a screen display, drive of a zoom lens and a focus lens, and operations of other imaging mechanisms.

In this embodiment, when the control IC 150 receives power supply from the main battery 120 with the FET switch unit 140 having been turned on by a potential output from the sub-battery 130, the control IC 150 outputs a potential to the FET switch unit 140 to maintain the on-state of the FET switch unit 140.

In this embodiment, when the control IC 150 has output a potential to the FET switch unit 140 to maintain the on-state of the FET switch unit 140, the sub-battery 130 can stop outputting a potential to the FET switch unit 140. Accordingly, power consumption of the sub-battery 130 can be suppressed.

The functional configuration of the electronic apparatus 100 in accordance with an embodiment of the present disclosure has been described above with reference to FIG. 2. Next, a specific circuit configuration example of the electronic apparatus 100 in accordance with an embodiment of the present disclosure will be described.

### [1-3. Circuit Configuration Example of Electronic Apparatus]

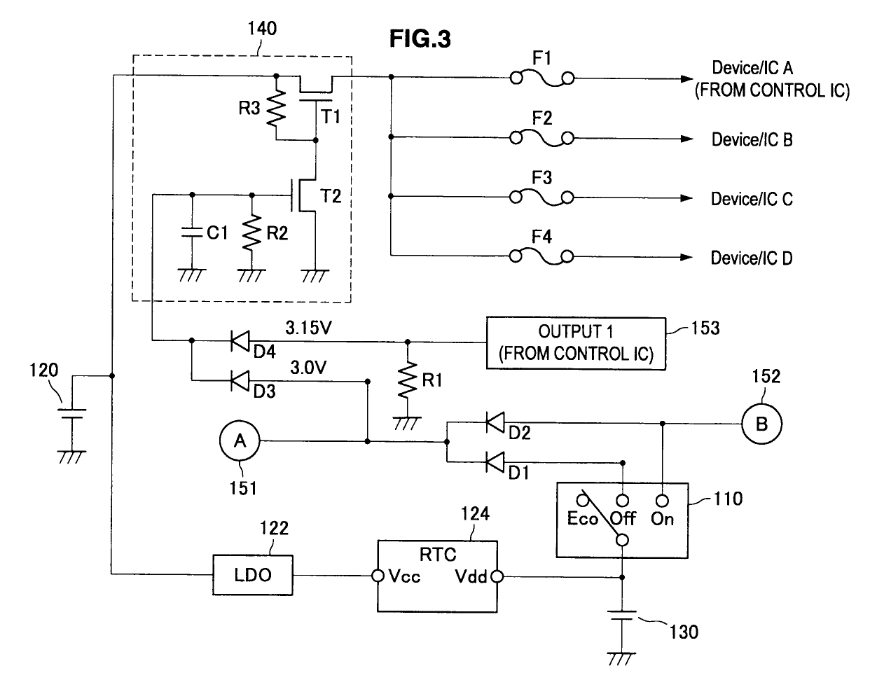

FIG. 3 is an explanatory diagram showing a circuit configuration example of the electronic apparatus 100 in accordance with an embodiment of the present disclosure. Hereinafter, a circuit configuration example of the electronic apparatus 100 in accordance with an embodiment of the present disclosure will be described with reference to FIG. 3.

The circuit configuration example of the electronic apparatus 100 in accordance with an embodiment of the present disclosure shown in FIG. 3 is a more specific functional configuration of the electronic apparatus 100 shown in FIG. 2. Hereinafter, each component of the electronic apparatus 100 shown in FIG. 2 will be specifically described.

The main switch 110 is a switch that can switch position among three positions as shown in FIG. 3. In FIG. 3, the three positions of the main switch 110 are indicated by “On,” “Off,” and “Eco” from the right side. The “On” position is a position for setting the operation mode of the electronic apparatus 100 to the power-on mode, the “Off” position is a position for setting the operation mode of the electronic apparatus 100 to the power-off mode, and the “Eco” position is a position for setting the operation mode of the electronic apparatus 100 to the eco-mode.

The main battery 120 not only supplies power to each device (e.g., the control IC 150) via the FET switch unit 140, which is turned on upon receiving a potential output, but also supplies power to an RTC (Real Time Clock) 124 via an LDO (Low Drop Out) 122.

The sub-battery 130 outputs a potential for turning the FET switch unit 140 on/off via the main switch 110. The potential for turning the FET switch unit 140 on/off is supplied to the FET switch unit 140 from the sub-battery 130 when the main switch 110 is at “On” position or “Off” position as can be seen in FIG. 3, and the potential for turning the FET switch unit 140 on/off is not output to the FET switch unit 140 when the main switch 110 is at “Eco” position.

The FET switch unit 140 includes an N-channel thin film transistor (FET) T1, a P-channel thin film transistor T2, a capacitor C1, and resistors R2 and R3. The thin film transistor T1 is turned on by a potential output from the sub-battery 130 or the control IC 150. When the thin film transistor T1 is turned on, the gate potential of the thin film transistor T2 becomes the ground potential, whereby the thin film transistor T2 is also turned on. When the thin film transistor T2 is turned on, power from the main battery 120 is supplied to the various circuits in the electronic apparatus 100. Note that power from the main battery 120 is supplied to the various circuits in the electronic apparatus 100 via fuses F1 to F4.

The operation of the circuit configuration example of the electronic apparatus 100 in accordance with an embodiment of the present disclosure shown in FIG. 3 will be described. When the main switch 110 is at “Eco” position, a potential for turning the FET switch unit 140 on is not output to the FET switch unit 140 from the sub-battery 130 as described above.

Herein, when the position of the main switch 110 is changed to “Off” position or “On” position by the user of the electronic apparatus 100, a potential for turning the FET switch unit 140 on is output from the sub-battery 130 to the FET switch unit 140. When the main switch 110 is at “Off” position, a potential for turning the FET switch unit 140 on is output from the sub-battery 130 to the FET switch unit 140 and also to an input port A of the control IC 150 denoted by reference numeral 151. However, this potential is not output to an input port B of the control IC 150 denoted by reference numeral 152. When the main switch 110 is at “On” position, a potential for turning the FET switch unit 140 on is output from the sub-battery 130 to the FET switch unit 140, and this potential is also output to each of the input port A and the input port B of the control IC 150.

When the position of the main switch 110 is changed to “Off” position or “On” position, a potential for turning the FET switch unit 140 on is output from the sub-battery 130 to the FET switch unit 140. Accordingly, the thin film transistors T1 and T2 are sequentially turned on, and power from the main battery 120 is supplied to the control IC 150 as described above.

The control IC 150 starts operation upon being supplied with power from the main battery 120. In this case, by detecting the states of the input ports A and B, the control IC 150 can know whether the main switch 110 is at “Off” position or “On” position. By detecting to which port a potential is output, the control IC 150 can know the current position of the main switch 110, and execute a process corresponding to the position.

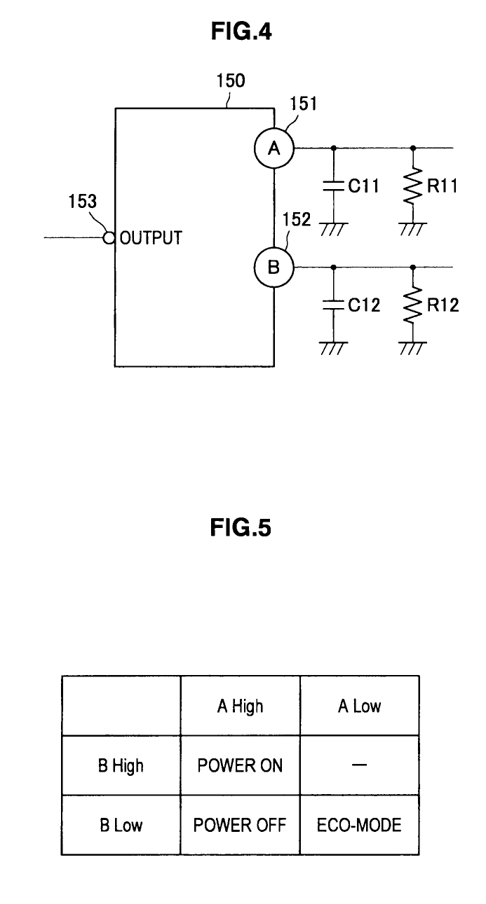

Next, a configuration example of the control IC 150 will be described. FIG. 4 is an explanatory diagram showing a configuration example of the control IC 150. As shown in FIG. 4, the control IC 150 includes the input port A denoted by reference numeral 151, the input port B denoted by reference numeral 152, and an output port 153 denoted by reference numeral 153.

Each of the input ports A and B receives a potential from the sub-battery 130, and the control IC 150 can detect whether each port is at high level or low level depending on the state of the potential.

When a potential from the sub-battery 130 is not output to the input port A or B, and each of the input ports A and B is at low level, the electronic apparatus 100 is in the eco-mode. Thus, the control IC 150 stops operation.

When the main switch 110 is at “Off” position, a potential from the sub-battery 130 is output to only the input port A. Thus, the control IC 150 can recognize that the input port A is at high level and the input port B is at low level. In such a state, the control IC 150 can recognize that the electronic apparatus 100 is in the power-off state.

When the main switch 110 is at “On” position, a potential from the sub-battery 130 is output to each of the input ports A and B. Thus, the control IC 150 can recognize that each of the input ports A and B is at high level. In such a state, the control IC 150 can recognize that the electronic apparatus 100 is in the power-on state.

The control IC 150, upon starting operation by being supplied with power from the main battery 120, outputs a potential for turning the FET switch unit 140 on from the output port 153. The potential for turning the FET switch unit 140 on output from the output port 153 is set higher than the potential for turning the FET switch unit 140 on output from the sub-battery 130. In the example shown in FIG. 3, the potential output from the sub-battery 130 is 3.0 V, and the potential output from the output port 153 is 3.15 V. When the potential output from the output port 153 is set higher than the potential output from the sub-battery 139, the potential output to the FET switch unit 140 will switch to the potential output from the output port 153 immediately after power is supplied to the control IC 150, so that the time during which the sub-battery 130 is used is limited to a short time. Thus, even when the sub-battery 130 is a power supply that is suitable for short-time power supply, a potential can be output to the FET switch unit 140 without any problem.

FIG. 5 is an explanatory table showing the relationship between the states of the input ports A and B of the control IC 150 and the operation mode of the electronic apparatus 100. FIG. 5 collectively shows the relationship between the states of the input ports A and B of the control IC 150 and the operation mode of the electronic apparatus 100.

As shown in FIG. 5, when each of the input ports A and B of the control IC 150 is at low level, the operation mode of the electronic apparatus 100 is the eco-mode. Thus, the control IC 150 stops operation.

When only the input port A of the control IC 150 is at high level and the input port B is at low level, the operation mode of the electronic apparatus 100 is the power-off mode. In the power-off mode, the control IC 150 is operating by being supplied with power from the main battery 120. The power-off state is realized by not operating the other circuits or devices in the electronic apparatus 100 or by supplying power only to the minimum circuits or devices.

When each of the input ports A and B of the control IC 150 is at high level, the operation mode of the electronic apparatus 100 is the power-on mode, and thus the electronic apparatus 100 can exert its function. Note that it is obvious from the configuration shown in FIG. 3 that there exists no state in which only the input port A of the control IC 150 is at low level and the input port B is at high level.

The circuit configuration example of the electronic apparatus in accordance with an embodiment of the present disclosure has been described above. Needless to say, the circuit configuration of the electronic apparatus 100 in accordance with an embodiment of the present disclosure is not limited to that shown in FIG. 3, and any circuit that can implement the functional configuration of the electronic apparatus 100 shown in FIG. 2 can be adopted. Next, the operation of the electronic apparatus 100 in accordance with an embodiment of the present disclosure will be described.

### [1-4. Operation of Electronic Apparatus]

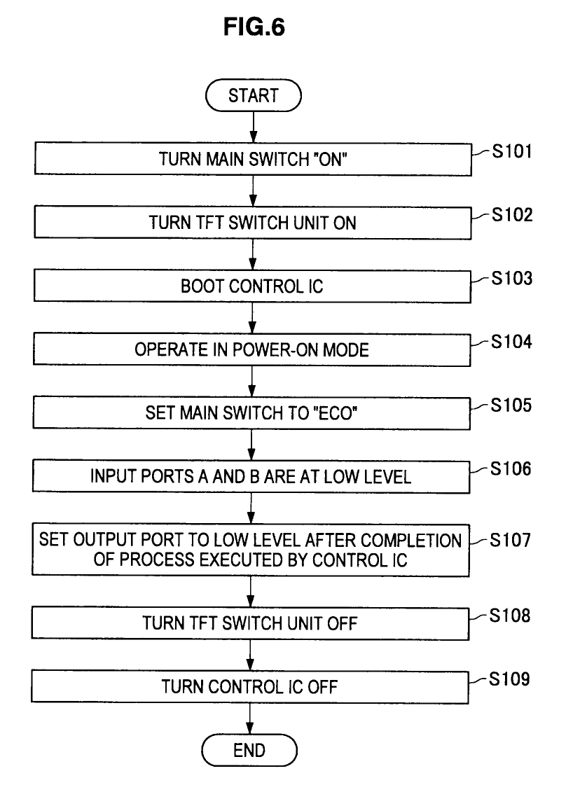

FIG. 6 is a flowchart showing the operation of the electronic apparatus 100 in accordance with an embodiment of the present disclosure. Hereinafter, the operation of the electronic apparatus 100 in accordance with an embodiment of the present disclosure will be described with reference to FIG. 6.

As a premise, it is assumed that the electronic apparatus 100 is set to the eco-mode by the main switch 110, namely, a state in which the control IC 150 is not supplied with power. In such a state, the main switch 110 is set to “On” position by the user of the electronic apparatus 100 (step S101). When the main switch 110 is set to “On” position, a potential is output from the sub-battery 130, and the thin film transistors T1 and T2 are sequentially turned on, whereby the FET switch unit 140 is turned on (step S102).

When the FET switch unit 140 is turned on with the thin film transistors T1 and T2 having been sequentially turned on, power of the main battery 120 is supplied to the control IC 150, and thus the control IC 150 is booted (step S103).

Once the control IC 150 is booted, the states of the input ports A and B can be detected. When the main switch 110 is set to “On” position, each of the input ports A and B receives a potential output from the sub-battery 130. Thus, the control IC 150 can detect that each of the input ports A and B is at high level.

As each of the input ports A and B is at high level, the control IC 150 can recognize that the electronic apparatus 100 is in the power-on mode. Thus, the control IC 150 causes the electronic apparatus 100 to operate in the power-on mode (step S104). After the control IC 150 is booted, the control IC 150 outputs a potential for turning the FET switch unit 140 on from the output port. Note that even after a potential for turning the FET switch unit 140 on is output from the output port 153 of the control IC 150, a potential output from the sub-battery 130 is continuously supplied to the input ports A and B. Thus, the control IC 150 can keep recognizing that the electronic apparatus 100 is in the power-on mode while the main switch 110 is at “On” position.

While the electronic apparatus 100 operates in the power-on mode, the user of the electronic apparatus 100 operates the main switch 110 to change the position of the main switch 110 to the “Eco” position (step S105). When the main switch 110 is set to the “Eco” position, the sub-battery 130 stops outputting a potential to the control IC 150. Then, the control IC 150 can detect that each of the input ports A and B is at low level (step S106).

When the main switch 110 is set to the “Eco” position and the control IC 150 detects that each of the input ports A and B is at low level, the control IC 150 changes the output of the output port 153 to low level after completing the process being executed (step S107). When the output of the output port 153 is at low level, the main switch 110 is at the “Eco” position. Thus, a potential output to the FET switch unit 140 stops. Thus, the thin film transistors T1 and T2 are sequentially turned off, and the FET switch unit 140 is turned off (step S108).

When the FET switch unit 140 is turned off, the power supply from the main battery 120 to the control IC 150 stops. Thus, when the FET switch unit 140 is turned off, the control IC 150 stops operation and enters an off-state (step S109).

When the position of the main switch 110 is changed from the “Eco” position to the “On” position as described above, a potential for turning the FET switch unit 140 on is output from the sub-battery 130 to the FET switch unit 140. When the FET switch unit 140 is turned on and power from the main battery 120 is supplied to the control IC 150, the potential output for turning the FET switch unit 140 on is switched from the sub-battery 130 to the control IC 150.

Meanwhile, when the position of the main switch 110 is changed from the “On” position to the “Eco” position, the control IC 150 stops outputting a potential for turning the FET switch unit 140 on after completing the process being executed. Accordingly, even when the position of the main switch 110 is suddenly changed from the “On” position to the “Eco” position, it is possible to turn the FET switch unit 140 off after completing the process being executed by the control IC 150.

### 2. Conclusion

As described above, according to an embodiment of the present disclosure, even when the position of the main switch 110 of the electronic apparatus 110 is changed from the “On” position to the “Eco” position, it is possible to physically shut off the power supply from the main battery 120 after waiting until completion of a process being executed by a circuit, which operates in the electronic apparatus 100, without forcibly stopping the process.

The electronic apparatus 100 in accordance with an embodiment of the present disclosure has the aforementioned configuration and executes the aforementioned operation, whereby it is possible to prolong the operable time of the electronic apparatus 100 after the electronic apparatus 100 has not been used and turn the FET switch unit 140 off safely when shutting off the power supply from the main battery 120.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, although the aforementioned embodiment has described a configuration in which the control IC 150 has the input ports A and B, and the control IC 150 detects the position of the main switch 110 by detecting whether each of the input ports A and B is at high level or low level, the present disclosure is not limited to such example. For example, the main switch 110 can output a signal corresponding to a position change to the control IC 150 so that the control IC 150 can detect the position of the main switch 110.

In addition, for example, although the aforementioned embodiment has described a configuration in which the electronic apparatus 100 has the main switch 100 that can have any of the three positions, and the control IC 150 detects which position the main switch 110 is at by detecting a potential output from the sub-battery 130, the present disclosure is not limited thereto. For example, a rotary switch can be used as the main switch 110, and the control IC 150 can detect which position the main switch 110 is at by detecting a rotation of the switch.

Further, a series of the processes described in the aforementioned embodiment can be executed by dedicated hardware or software (an application). When a series of the processes is performed by software, the series of the processes can be implemented by causing a general-purpose or dedicated computer to execute a program.

The present disclosure contains subject matter related to that disclosed in Japanese Priority Patent Application JP 2011-060895 filed in the Japan Patent Office on Mar. 18, 2011, the entire content of which is hereby incorporated by reference.

What is claimed is:

1. An electronic apparatus comprising:
a first battery and a second battery;
a control unit configured to control an operation of the electronic apparatus;
a first switch configured to switch whether or not to supply power from the first battery to the control unit; and
a second switch configured to switch whether or not to supply a potential from the second battery to the first switch,
wherein when power from the first battery is supplied to the control unit, the control unit applies to the first switch a potential for supplying power from the first battery to the control unit.

2. The electronic apparatus according to claim 1, wherein the control unit, upon detecting that the second switch has set a stop of power supply from the first battery and a stop of an operation of the control unit, stops supplying a potential to the first switch and turns the first switch off after completing a process being executed.

3. The electronic apparatus according to claim 2, wherein the control unit has a terminal that detects a start and a stop of the power supply from the first battery by the second switch.

4. The electronic apparatus according to claim 1, wherein when the control unit outputs a potential for maintaining an on-state of the first switch, the second battery stops supplying a potential to the first switch.

5. The electronic apparatus according to claim 1, wherein the potential output from the control unit to the first switch is higher than the potential output from the second battery to the first switch.

6. The electronic apparatus according to claim 1, wherein the second battery has lower capacity than the first battery.

7. The electronic apparatus according to claim 1, wherein the first switch includes a first FET and a second FET, the first FET being configured to be turned on upon being supplied with a potential from the second battery by the second switch, and the second FET being configured to be turned on when the first FET is turned on and supply power from the first battery to the control unit.

8. A power supply control method for an electronic apparatus, the electronic apparatus including a first battery and a second battery, a control unit configured to control an operation of the electronic apparatus, a first switch configured to switch whether or not to supply power from the first battery to the control unit, and a second switch configured to switch whether or not to supply a potential from the second battery to the first switch, the method comprising:
applying a potential from the second battery to the first switch by the second switch; and
applying to the first switch, when the first switch is turned on and power from the first battery is supplied to the control unit, a potential for supplying power from the first battery to the control unit.
